(19) United States
(12) Patent Application Publication
(10) Pub. No.: US 2011/0151815 A1
(43) Pub. Date: Jun. 23, 2011

(54) SYSTEM AND METHOD FOR IDENTIFYING GAUSSIAN RADIO NOISE

(75) Inventor: Seung Keun PARK, Daejeon (KR)

(73) Assignee: ELECTRONICS AND TELECOMMUNICATIONS RESEARCH INSTITUTE, Daejeon (KR)

(21) Appl. No.: 12/965,566

(22) Filed: Dec. 10, 2010

(30) Foreign Application Priority Data
Dec. 17, 2009 (KR) 10-2009-0125959
Feb. 9, 2010 (KR) 10-2010-0011768

(51) Int. Cl. H04B 17/00

(52) U.S. Cl. 455/226.1

(57) ABSTRACT

Provided is a system and method of identifying Gaussian radio noise. The Gaussian radio noise identifying system may determine whether measured data of radio noise indicates a Gaussian distribution. The Gaussian radio noise identifying system may determine whether the measured data indicates the Gaussian distribution through a matching test consisting of two operations. The operations may include a matching test between an average estimate value of measured and a ½, and a matching test between a standard deviation estimate value and a result value obtained by dividing an H-range by a predetermined value. Accordingly, it is possible to enhance a determination accuracy.

### CROSS-REFERENCE TO RELATED APPLICATIONS

This application claims the benefit of Korean Patent Application No. 10-2009-0125959, filed on Dec. 17, 2009, and Korean Patent Application No. 10-2010-0011768, filed on Feb. 9, 2010, in the Korean Intellectual Property Office, the disclosures of which are incorporated herein by reference.

### BACKGROUND

1. Field of the Invention

The present invention relates to a system and method for measuring radio noise to determine whether the measured radio noise corresponds to Gaussian radio noise.

2. Description of the Related Art

In a radio noise measurement, identifying of a Gaussian distribution becomes an issue. In a conventional radio noise measurement scheme, whether radio noise indicates a Gaussian distribution has been determined using only matching between a median and an average estimate value of measured data. However, the conventional radio noise measurement scheme has a relatively low accuracy in determining whether radio noise indicates the Gaussian distribution.

In particular, when measured data indicates a uniform distribution or the Gaussian distribution, the average estimate value may match the median. In this case, when the conventional scheme is applied, a determination result regarding whether the radio noise indicates the Gaussian distribution or the uniform distribution is uncertain and thus, a determination accuracy may decrease. Accordingly, there is a desire for a method that may determine whether radio noise indicates a Gaussian distribution.

### SUMMARY

An aspect of the present invention provides a method and system that may more accurately determine whether radio noise indicates a Gaussian distribution based on an average estimate value of measured data, a standard deviation estimate value of the measured data, and a quartile.

According to an aspect of the present invention, there is provided a system for identifying Gaussian radio noise, the system including: a measured data gathering unit to gather measured data of radio noise; an estimate value calculator to calculate an average estimate value of the measured data and a standard deviation estimate value of the measured data; a quartile calculator to calculate a quartile based on the measured data; and a noise distribution determining unit to determine whether the measured data corresponds to a Gaussian distribution, based on the average estimate value, the standard deviation estimate value, and the quartile.

The Gaussian radio noise identifying system may further include: a first comparator to compare the average estimate value with a ½ quartile of the quartile; and a second comparator to compare the standard deviation estimate value with an H-range that is a difference between a ¾ quartile and a ¼ quartile of the quartile.

According to another aspect of the present invention, there is provided a method of identifying Gaussian radio noise, the method including: gathering measured data of radio noise; calculating an average estimate value of the measured data and a standard deviation estimate value of the measured data; calculating a quartile based on the measured data; and determining whether the measured data corresponds to a Gaussian distribution based on the average estimate value, the standard deviation estimate value, and the quartile.

The method may further include: comparing the average estimate value with a ½ quartile of the quartile; and comparing the standard deviation estimate value with an H-range that is a difference between a ¾ quartile and a ¼ quartile of the quartile.

According to embodiments of the present invention, it is possible to more accurately determine whether radio noise indicates a Gaussian distribution through a matching consisting of two operations. One operation is a matching test about matching between an average estimate value of measured data and a ½ quartile, and another operation is a matching test based on a standard deviation estimate value and an H-range according to a ¼ quartile and a 3/quartile.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of a Gaussian radio noise identifying system according to an embodiment of the present invention;

FIG. 2 is a graph illustrating relationship between a Gaussian distribution of radio noise and a quartile according to an embodiment of the present invention;

FIG. 3 is a graph illustrating a probability density function of a uniform distribution and a Gaussian distribution with respect to radio noise according to an embodiment of the present invention; and

FIG. 4 is a flowchart illustrating a method of determining a Gaussian distribution according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

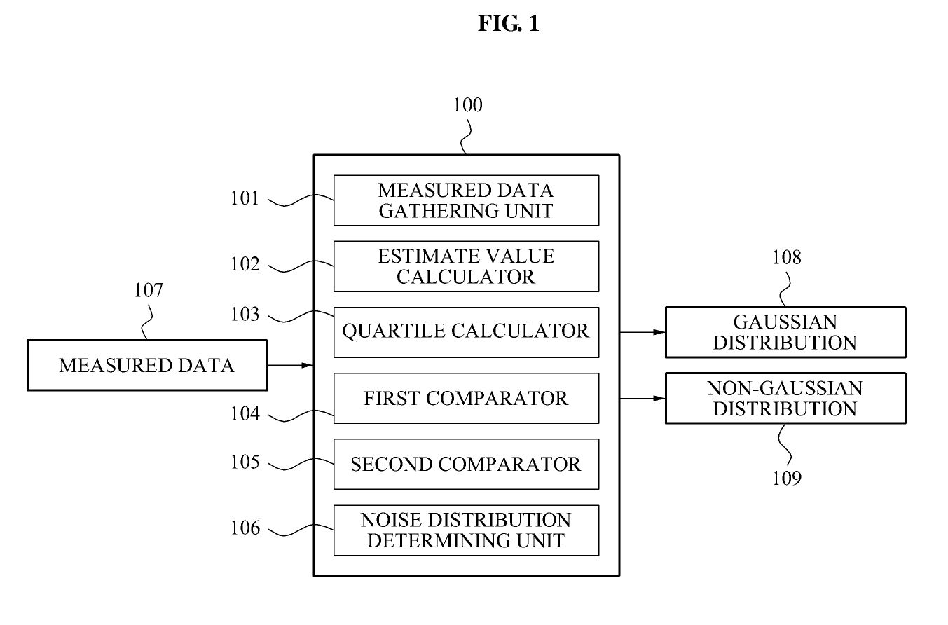

FIG. 1 is a block diagram illustrating a configuration of a Gaussian radio noise identifying system 100 according to an embodiment of the present invention.

Referring to FIG. 1, the Gaussian radio noise identifying system 100 may include a measured data gathering unit 101, an estimate value calculator 102, a quartile calculator 103, a first comparator 104, a second comparator 105, and a noise distribution determining unit 106.

The measured data gathering unit 102 may gather measured data 107 that is obtained by measuring radio noise. There is no particular constraint on a number of pieces of measured data 107.

The estimate value calculator 102 may calculate an average estimate value of the measure data 107 with respect to the radio noise and a standard deviation estimate value thereof.

For example, when the measured data 107 includes x₁, x₂, . . . , xₙ, the average estimate value of the measured data 107 may be calculated according to the following Equation 1.

$$m = \frac{1}{n} {\sum }_{i = 1}^{n} {x}_{i} \qquad [ Equation 1 ]$$

Specifically, according to Equation 1, the estimate value calculator 102 may calculate the average estimate value of the measured data 107 by dividing n pieces of measured data 107 by n.

The standard deviation estimate value of the measured data 107 may be determined according to the following Equation 2.

$$s = \sqrt{\frac{1}{n - 1} {\sum }_{i = 1}^{n} {( {x}_{i} - m )}^{2}} \qquad [ Equation 2 ]$$

The quartile calculator 103 may calculate a quartile using the measured data 107. In this instance, the quartile calculator 103 may calculate a quartile with respect to a Gaussian distribution of the measured data 107. For example, the quartile may be a ½ quartile (median), a ¼ quartile, and a ¾ quartile with respect to the measured data 107.

For example, the quartile calculator 103 may calculate the quartile by referring to Table 1 below when the average of the measured data 107 is μ and the standard deviation of the measured data 107 is a based on a Gaussian distribution theory. In Table 1, 0.6745 may be modified according to a system configuration.

TABLE 1

| Quartile | Value corresponding to quartile |
|---|---|
| ¼ quartile (Q1) | μ − 0.6745 σ |
| ½ quartile (median) (Q2) | μ |
| ¾ quartile (Q3) | μ + 0.6745 σ |

The first comparator 104 may compare the average estimate value with a ½ quartile of the quartile. For example, the first comparator 104 may determine whether a difference between the average estimate value and the ½ quartile is included within a predetermined error range.

The second comparator 105 may compare the standard deviation estimate value with an H-range that is a difference between a ¾ quartile and a ¼ quartile of the quartile. For example, the second comparator 105 may determine whether a difference between the standard deviation estimate value and a result value obtained by dividing the H-range by the predetermined value is included within the predetermined error range.

For example, the H-range corresponds to a value indicating to what extent data is spread. Referring to Table 1, the H-range may be determined according to Equation 3 below. Using the relationship between the H-range and the standard deviation σ, the Gaussian radio noise identifying system 100 may determine whether the measured radio noise indicates a Gaussian distribution 108.

H-range=1.349σ [Equation 3]

In this instance, when the standard deviation estimate value is s, the standard deviation estimate value may be determined according to the following Equation 4.

s=H-range/1.349 [Equation 4]

The error range employed by the first comparator 104 and the second comparator 105 may be determined according to the following Equation 5.

|(s−(H-range/1.349))/s|*100=E %, [Equation 5]

where s denotes the standard deviation estimate value and E denotes the error range.

The noise distribution determining unit 106 may determine whether the measured data 107 indicates the Gaussian distribution 108, based on the average estimate value, the standard deviation estimate value, and the quartile. For example, the noise distribution determining unit 106 may determine whether the measured data 107 indicates the Gaussian distribution 108, based on a comparison result of the first comparator 104 and a comparison result of the second comparator 105.

For example, when the difference between the average estimate value and the ½ quartile is included within the predetermined error range, and when the difference between the standard deviation estimate value and the result value obtained by dividing the H-range by the predetermined value is included within the predetermined error range, the noise distribution determining unit 106 may determine the measured data 107 as the Gaussian distribution 108.

When the difference between the average estimate value and the ½ quartile is outside the predetermined error range, or when the difference between the standard deviation estimate value and the result value obtained by dividing the H-range by the predetermined value is outside the predetermined error range, the noise distribution determining unit 106 may determine the measured data 107 as a non-Gaussian distribution 109.

For example, when the average estimate value of the measured data 107 and the ½ quartile (median) match within the error range, and when the standard deviation estimate value of the measured data 107 and (H-range/1.349) match within the error range, the noise distribution determining unit 106 may determine a distribution of the measured data 107 as the Gaussian distribution 108. Conversely, when the average estimate value of the measured data 107 and the ½ quartile (median) do not match within the error range, or when the standard deviation estimate value of the measured data 107 and (H-range/1.349) do not match within the error range, the noise distribution determining unit 106 may determine a distribution of the measured data 107 as a non-Gaussian distribution 109.

Accordingly, whether the measured data 107 of the radio noise indicates the Gaussian distribution 108 may be determined through a total of two operations of determining matching between the average estimate value of the measured data 107 and the ½ quartile and determining matching between the standard deviation estimate value of the measured data 107 and (H-range/1.349). All of the above two operations need to be satisfied so that the measured data 107 of the distribution noise may be determined as the Gaussian distribution 108. When either of the operations is not satisfied, the measured data 107 of the radio noise may be determined as the non-Gaussian distribution 109.

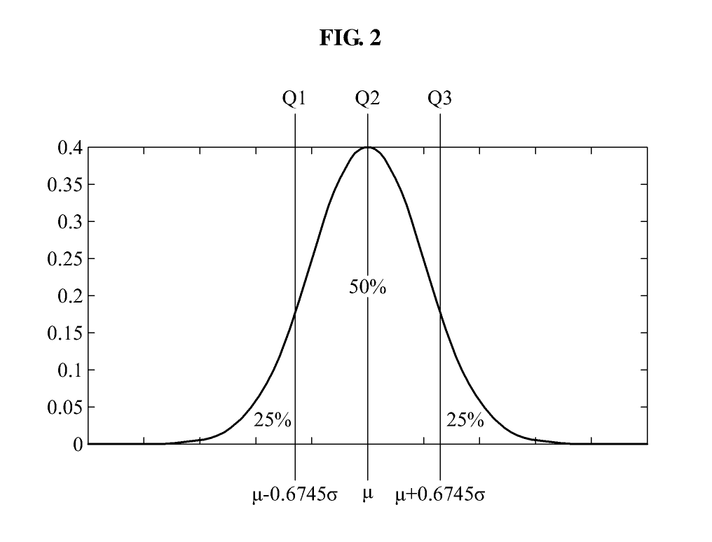

FIG. 2 is a graph illustrating relationship between a Gaussian distribution of radio noise and a quartile according to an embodiment of the present invention.

The graph of FIG. 2 shows a case where the radio noise indicates the Gaussian distribution. Here, Q1 denotes a ¼ quartile, Q2 denotes a ½ quartile (median), and Q3 denotes a ¾ quartile. An interval between Q3 and Q1 indicates an H-range. Specifically, the H-range may be determined according to Equation 3.

According to an embodiment of the present invention, to determine whether the radio noise indicates the Gaussian distribution as shown in FIG. 2, the Gaussian radio noise identifying system 100 may experience two matching determining operations. Initially, the Gaussian radio noise identifying system 100 may determine whether the average estimate value of measured data and the ½ quartile match. The Gaussian radio noise identifying system 100 may determine whether the standard deviation estimate value of measured data and (H-range/0.349) match.

For example, when the average estimate value of measured data is positioned around Q2, and when the standard deviation estimate value of measured data matches an interval between Q1 and Q3 to some degrees, the Gaussian radio noise identifying system 100 may determine a noise distribution of measured data as the Gaussian distribution.

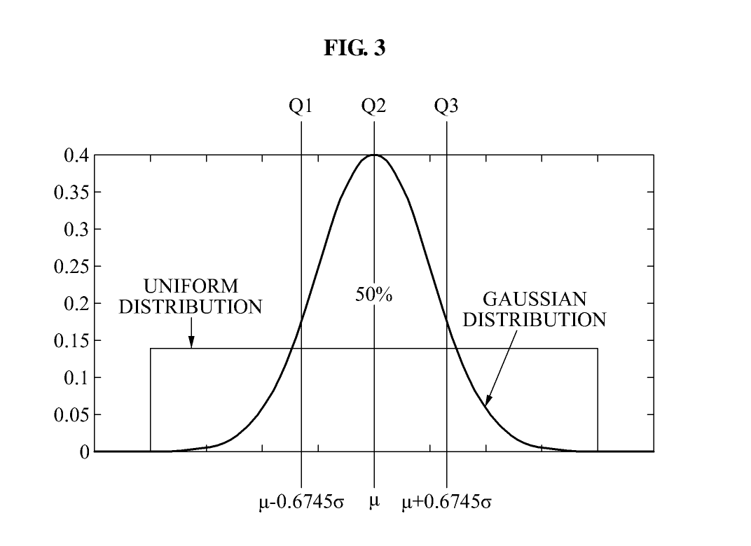

FIG. 3 is a graph illustrating a probability density function of a uniform distribution and a Gaussian distribution with respect to radio noise according to an embodiment of the present invention.

When the noise distribution of measured data is determined as the Gaussian distribution by determining only matching between the average estimate value of measured data and the ½ quartile, the same result may be induced and thereby an accuracy may decrease even though the radio noise indicates the Gaussian distribution or the uniform distribution.

According to an embodiment of the present invention, the Gaussian radio noise identifying system 100 may determine whether the average estimate value of measured data and the ½ match. The Gaussian radio noise identifying system 100 may also determine whether the standard deviation estimate value of measured data and (H-range/1.349) match.

Specifically, whether the measured data of radio noise indicates the Gaussian distribution may be determined through two operations of determining matching. When actual radio noise indicates the uniform distribution, the actual radio noise may not be determined as the Gaussian distribution even though the present invention is applied. According to an embodiment of the present invention, it is possible to more accurately determine whether the radio noise indicates the Gaussian distribution.

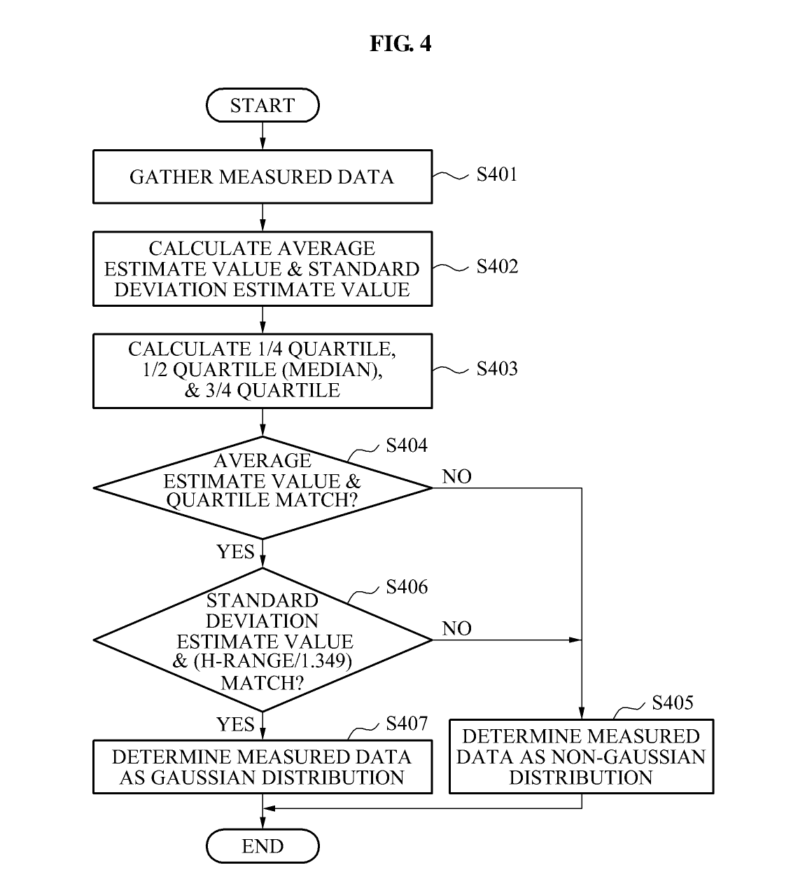

FIG. 4 is a flowchart illustrating a method of determining a Gaussian distribution according to an embodiment of the present invention.

In operation S401, the Gaussian radio noise identifying system 100 may gather x₁, x₂, . . . , xₙ corresponding to measured data of radio noise.

In operation S402, the Gaussian radio noise identifying system 100 may calculate an average estimate value of measured data and a standard deviation estimate value of measured data.

In operation S403, the Gaussian radio noise identifying system 100 may calculate a ¼ quartile, a ½ quartile (median), and a ¾ quartile with respect to the measured data.

In operation S404, the Gaussian radio noise identifying system 100 may determine whether the average estimate value and the ½ quartile (median) match. Specifically, the Gaussian radio noise identifying system 100 may determine whether a difference between the average estimate value and the ½ quartile is included within a predetermined error range. When the average estimate value and the ½ quartile match, operation S406 may be performed and otherwise, the Gaussian radio noise identifying system 100 may determine the measured data indicates a non-Gaussian distribution in operation S405.

In operation S406, the Gaussian radio noise identifying system 100 may determine whether the standard deviation estimate value and (H-range/1.349) match. Specifically, the Gaussian radio noise identifying system 100 may determine whether the difference between the standard deviation estimate value and (H-range/1.349) is included within the predetermined error range.

When the standard deviation estimate value and (H-range/1.349) match, the Gaussian radio noise identifying system 100 may determine the measured data indicates the Gaussian distribution in operation S407. Conversely, when they do not match, the Gaussian radio noise identifying system 100 may determine the measured data indicates the non-Gaussian distribution in operation S405.

The above-described exemplary embodiments of the present invention may be recorded in computer-readable media including program instructions to implement various operations embodied by a computer. The media may also include, alone or in combination with the program instructions, data files, data structures, and the like. Examples of program instructions include both machine code, such as produced by a compiler, and files containing higher level code that may be executed by the computer using an interpreter.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A system for identifying Gaussian radio noise, the system comprising:
a measured data gathering unit to gather measured data of radio noise;
an estimate value calculator to calculate an average estimate value of the measured data and a standard deviation estimate value of the measured data;
a quartile calculator to calculate a quartile based on the measured data; and
a noise distribution determining unit to determine whether the measured data corresponds to a Gaussian distribution, based on the average estimate value, the standard deviation estimate value, and the quartile.

2. The system of claim 1, wherein the quartile calculator calculates the quartile with respect to a Gaussian distribution of the measured data.

3. The system of claim 1, further comprising:
a first comparator to compare the average estimate value with a ½ quartile of the quartile; and
a second comparator to compare the standard deviation estimate value with an H-range that is a difference between a ¾ quartile and a ¼ quartile of the quartile.

4. The system of claim 3, wherein the noise distribution determining unit determines whether the measured data corresponds to the Gaussian distribution, based on the comparison result of the first comparator and the comparison result of the second comparator.

5. The system of claim 4, wherein when a difference between the average estimate value and the ½ quartile is included within a predetermined error range, and when a difference between the standard deviation estimate value and a result value obtained by dividing the H-range by a predetermined value is included within the predetermined error range, the noise distribution determining unit determines the measured data as the Gaussian distribution.

6. The system of claim 4, wherein when a difference between the average estimate value and the ½ quartile is outside a predetermined error range, or when a difference between the standard deviation estimate value and a result value obtained by dividing the H-range by a predetermined value is outside the predetermined error range, the noise distribution determining unit determines the measured data as a non-Gaussian distribution.

7. A method of identifying Gaussian radio noise, the method comprising:
gathering measured data of radio noise;
calculating an average estimate value of the measured data and a standard deviation estimate value of the measured data;
calculating a quartile based on the measured data; and
determining whether the measured data corresponds to a Gaussian distribution based on the average estimate value, the standard deviation estimate value, and the quartile.

8. The method of claim 7, wherein the calculating of the quartile comprises calculating the quartile with respect to a Gaussian distribution of the measured data.

9. The method of claim 7, further comprising:
comparing the average estimate value with a ½ quartile of the quartile; and
comparing the standard deviation estimate value with an H-range that is a difference between a ¾ quartile and a ¼ quartile of the quartile.

10. The method of claim 9, wherein the determining comprises determining whether the measured data corresponds to the Gaussian distribution, based on the comparison result between the average estimate value and the ½ quartile and the comparison result between the standard deviation estimate value with the H-range.

11. The method of claim 10, wherein the determining comprises determining the measured data as the Gaussian distribution when a difference between the average estimate value and the ½ quartile is included within a predetermined error range, and when a difference between the standard deviation estimate value and a result value obtained by dividing the H-range by a predetermined value is included within the predetermined error range.

12. The method of claim 10, wherein the determining comprises determining the measured data as a non-Gaussian distribution when a difference between the average estimate value and the ½ quartile is outside a predetermined error range, or when a difference between the standard deviation estimate value and a result value obtained by dividing the H-range by a predetermined value is outside the predetermined error range.
